(19) United States
(12) Patent Application Publication
(10) Pub. No.: US 2018/0371949 A1
(43) Pub. Date: Dec. 27, 2018

(54) PLANT SYSTEMS

(71) Applicant: Dürr Systems AG, Bietigheim-Bissingen (DE)

(72) Inventors: Josip Kutnjak, Bietigheim-Bissingen (DE); Urs Ertel, Ditzingen (DE); Moritz Nett, Stuttgart (DE); Axel Widenhorn, Stuttgart (DE)

(21) Appl. No.: 16/117,665

(22) Filed: Aug. 30, 2018

Related U.S. Application Data
(63) Continuation-in-part of application No. PCT/EP2017/054212, filed on Feb. 23, 2017.

(30) Foreign Application Priority Data
Mar. 4, 2016 (DE) 10 2016 203 620

(51) Int. Cl. F01D 25/28; F01D 15/10; F02C 7/10

(52) U.S. Cl. CPC F01D 25/28; F01D 15/10; F05D 2250/42; F05D 2230/642; F05D 2250/311; F02C 7/10

(57) ABSTRACT

Plant systems are disclosed A disclosed example plant system includes a first assembly carried by a machine frame, and a second assembly coupled to an interface of the first assembly, where the interface has an interface axis along which at least one of a force flux, a torque flux, or a media flux can take pass from the first assembly and into the second assembly via the interface. The machine frame carries the second assembly.

### RELATED APPLICATIONS

This patent arises as a continuation-in-part of International Patent Application No. PCT/EP2017/054212, which was filed on Feb. 23, 2017, which claims priority to German Patent Application No. 10 2016 203 620, which was filed on Mar. 4, 2016. The foregoing International Patent Application and the German Patent Application are hereby incorporated herein by reference in their entireties.

### FIELD OF THE DISCLOSURE

This disclosure relates generally to industrial processing systems, and, more particularly, to plant systems.

### BACKGROUND

Plant systems are frequently used in complex plants, for example, to generate electrical or mechanical energy or to make a chemical reaction possible. In a plant system implemented as a gas turbine system, the turbine can be configured, for example, for power on the order of magnitude of 1 MW (megawatt).

### BRIEF DESCRIPTION OF THE DRAWINGS

FIG. 1 shows a circuit diagram of an example plant system, which includes a first assembly implemented as a turbo module with a turbine that can be acted upon with (e.g., provided with) hot gas from a combustion chamber, and including a second assembly implemented as a recuperator.

FIG. 2 shows a schematic side view of the example plant system, which includes a first machine frame for accommodating the first assembly and the second assembly.

FIG. 3 shows a schematic front view of the example plant system along the direction of the arrow II from FIG. 2 with the machine frame.

FIG. 4 shows a three dimensional partial view of the example plant system with the machine frame.

FIG. 5 shows a portion of the second assembly in the example plant system with an additional bearing point.

FIG. 6 shows the arrangement of bearing points of the first assembly and of the second assembly with respect to the axis of rotation of the rotor on the machine frame.

FIG. 7 shows a partial view of a second machine frame for accommodating a first assembly implemented as a turbo module and a second assembly implemented as a recuperator in the example plant system, shown as a three-dimensional section.

FIG. 8 shows a partial view of a third machine frame for accommodating a first assembly implemented as a turbo module with a gas turbine and a second assembly implemented as a recuperator in the example plant system.

FIG. 9 shows a fourth machine frame for accommodating a first assembly implemented as a gas turbine and a second assembly implemented as a recuperator in the example plant system.

FIG. 10 shows a first partial view of the example plant system with the fourth machine frame.

FIG. 11 shows a second partial view of the example plant system with the fourth machine frame.

FIG. 12 shows a third partial view of the example plant system with the fourth machine frame.

FIG. 13 shows a further partial view of the example plant system with the fourth machine frame and with a supporting device for supporting a generator in the plant system.

FIG. 14 shows a further partial view of the example plant system with the fourth machine frame and the supporting device for supporting a generator.

FIG. 15 shows an additional partial view of the example plant system with the fourth machine frame and the supporting device, where the first assembly with the turbo module is removed from the second assembly implemented as the recuperator.

The figures are not to scale. Instead, the thickness of the layers or regions may be enlarged in the drawings. In general, the same reference numbers will be used throughout the drawing(s) and accompanying written description to refer to the same or like parts. As used in this patent, stating that any part is in any way on (e.g., positioned on, located on, disposed on, or formed on, etc.) another part, indicates that the referenced part is either in contact with the other part, or that the referenced part is above the other part with one or more intermediate part(s) located therebetween. Stating that any part is in contact with another part means that there is no intermediate part between the two parts.

### DETAILED DESCRIPTION

Plant systems are disclosed. Examples disclosed herein relate to a plant system including a first assembly accommodated on a machine frame and a second assembly coupled to an interface of the first assembly, where the interface has an interface axis along which a force flux, torque flux and/or media flux can move from the first assembly into the second assembly via the interface.

In general, plant systems are frequently used in complex plants, for example, to generate electrical or mechanical energy or to make a chemical reaction possible. A known plant system of this type is known from GB 694,043 A, which is hereby incorporated in its entirety. This known plant system is implemented as a gas turbine plant and includes a first assembly implemented as a turbo module having a turbine, as well as a second assembly with a heat exchanger. The first assembly with the turbine and the second assembly with the heat exchanger are supported on a machine frame. The first assembly includes the turbine and a compressor, which is coupled/connected to the turbine, both of which are mounted in this known example to a pin bearing, in which the first assembly, the turbine and the compressor can be pivoted about the horizontal axis of the pin and can be moved in a direction parallel to the axis of the pin and in the direction, which is perpendicular thereto, along a horizontal plane. The axis of the interface of the first assembly with the turbine and the second assembly with the heat exchanger runs perpendicularly to the horizontal plane, in which the pin is arranged. Movability of the first assembly as the turbo module along the axis of the interface relative to the second assembly with the heat exchanger is not provided.

US 2003/0061816 A1, which is incorporated by reference in its entirety, mentions a known gas turbine system with a recuperator assembly and a first gas turbine, as well as a second gas turbine. The recuperator assembly is mounted on three bearing points and is coupled, via the gas turbine, to the interface. However, the first gas turbine cannot be moved and/or shifted here on the machine frame. Although the second gas turbine is arranged in a movable manner on the machine frame, it cannot be moved in relation to the recuperator in this known system.

In a plant system implemented as a gas turbine system, the turbine can be configured, for example, for power on the order of magnitude of 1 MW (megawatt).

A first example assembly of a plant system in accordance with the teachings of this disclosure can be, for example, a turbo module having a turbine, which can be acted upon with hot gas from a combustion chamber, includes a turbine rotor. The turbine rotor is positioned/arranged in a turbine housing and is rotatable about an axis of rotation that is coaxial with respect to the interface axis, and, upon being acted upon with hot gas, releases an exhaust gas flow from the combustion chamber. The example turbine module includes, for example, a compressor, which is rotationally coupled to the turbine rotor, to generate compressed additional air, which can be provided into the combustion chamber. The second assembly can be, for example, a recuperator that is coupled to the interface by the turbo module and can be acted upon in the direction of the interface axis with the exhaust gas flow to transfer heat from the exhaust gas flow to the additional air, which is compressed by a compressor.

In some examples, the plant system of examples disclosed herein can be a micro gas turbine. As used herein, a micro gas turbine refers to a gas turbine system with a relatively small high-speed turbine having relatively low combustion chamber pressures and combustion chamber temperatures. For example, the power of a micro gas turbine can be less than 300 kW (kilowatt) and can have a range approximately between 20 kW and 100 kW, for example. Accordingly, this example design of micro gas turbines is distinct from the design of known conventional industrial gas turbines.

A micro gas turbine generally includes (e.g., contains) a compressor, a combustion chamber and a turbine. Similar to an industrial gas turbine, a micro gas turbine, thus, operates according a gas turbine process. According to this gas turbine process, air is drawn from the surroundings and compressed in a compressor. In turn, the compressed air is then provided to a combustion chamber in which, as a result of the addition of fuel (e.g., gas or oil), a combustion reaction takes place as flue gas arises. Accordingly, the flue gas is then expanded in the turbine of the micro gas turbine. The turbine first drives the compressor and second, a generator for generating power, for example.

In an industrial gas turbine, the expanded flue gas exits the turbine with an exhaust gas flow. The temperature of the exhaust gas flow can have a value within a range between 400° C. (Celsius) and 700° C., for example. The residual heat contained in the exhaust gas flow of the industrial gas turbine is regularly used for heating up media in an industrial plant, e.g. for heating up water.

In contrast to an industrial gas turbine, a micro gas turbine, generally includes a recuperator. In particular, a recuperator is a heat exchanger that pre-heats compressed air by waste heat from the exhaust gas of the turbine in the micro gas turbine, such that the air is supplied together with fuel to a combustion chamber for combustion. Due to implementation of the recuperator, the micro gas turbine is a gas turbine system that, in comparison to conventional industrial gas turbines, can be operated in the power range between 25 kW and 100 kW with a relatively higher electrical efficiency. The pre heating of the compressed air enables the recuperator to reduce exhaust gas heat losses.

Based on the thermal expansion of the gas turbine and of the recuperator when the plant is in operation, measures can be taken in a gas turbine plant to ensure that the thermal elongations/expansions are absorbed and no significant additional stress occurs in the components/assemblies. This stress can lead to increased wear and failure of assemblies and components in the gas turbine.

Similar forces resulting from thermal expansion can arise if the first assembly is, for example, implemented as a turbine with a turbine rotor that is arranged in a turbine housing and rotatable about an axis of rotation that is coaxial with respect to the interface axis, and the second assembly is implemented as a transmission coupled to the interface with the turbine rotor and/or a generator coupled to the interface with the turbine rotor. In some examples, the same applies if the first assembly is implemented as an engine of an internal combustion engine (e.g., a piston engine) and the second assembly is implemented as a transmission coupled to the interface with the output shaft of the engine or a generator coupled to the output shaft of the engine.

Known plant systems, which include a turbo module and a recuperator, have a machine frame with a base to support the turbo module having a first and a second turbo machine supporting part. In particular, the first turbo machine supporting part is secured to the base and receives the turbo module in a ball and socket joint. Further, the second turbo machine supporting part holds the turbo module with an additional ball and socket joint and is coupled to the base in an articulated manner. The recuperator is supported on the frame by a recuperator supporting part. The recuperator supporting part is accommodated on the base of the machine frame by a movable bearing and holds the recuperator via a ball and socket joint. Due to the turbo module being coupled to the recuperator, an assembly is defined that is held in a three point bearing by the first and second turbo machine supporting parts and the recuperator supporting part of the machine frame.

If, in the example of this known plant system, the turbo module is removed, (e.g., for maintenance work), the recuperator is to be removed or fixed in a complicated manner.

It is the object of examples disclosed herein to provide a plant system in which removal of the first assembly is enabled without a second assembly, which is coupled to the first assembly, having to be removed simultaneously, and in which thermal expansion of elements of the first assembly and/or the second assembly when the plant is in operation does not lead to the occurrence of forces which are introduced from the first assembly into the second assembly, or vice versa.

This object is achieved by a plant system, which is implemented as a gas turbine system, with features described herein. Advantageous embodiments of examples disclosed herein are described herein.

In a plant system in accordance with teachings of this disclosure, the machine frame also supports and/or bears the second assembly.

One aspect of examples disclosed herein is to hold and/or support the turbine and a recuperator on a machine frame in a gas turbine system in such a manner that both the recuperator housing and the turbine housing of the turbine can thermally expand with little or no resultant forces that can potentially deform the turbine housing. Further, this thermal expansion can be asymmetrical with respect to the axis of rotation of the gas turbine and, therefore, lead to changes in the radial distances of rotor and turbine within the turbine housing. According to examples disclosed herein, one and the same machine frame is provided for this purpose to hold and support a turbine and a recuperator in a gas turbine system. The component axes of the recuperator and the turbine are positioned coaxially with respect to each other, and the receiving points of said assemblies on the machine frame lie in a plane in which the two component axes are located. It should be noted that, in some particular examples, a generator that is coupled to the compressor side and includes a compressor rotor, which is rotationally coupled to the turbine rotor, can be provided on the turbine.

For example, it is a concept of examples disclosed herein that the second assembly is accommodated on a three point bearing of the machine frame. The aforementioned three point bearing, preferably, includes a first bearing formed on the machine frame, a second bearing that is formed on the machine frame and is spaced apart from the first bearing, and an additional bearing, which is formed on the machine frame, to hold the second assembly. The second assembly is accommodated in this example on a first bearing point in the first bearing and on a second bearing point in the second bearing, and also on an additional bearing point in the additional bearing.

In some examples, the first bearing and the second bearing, preferably, have bearing axes that are arranged with respect to the pivot axis. The bearing axes intersect the machine axis preferably perpendicularly and then define a preferably horizontal plane with the machine axis, for example.

According to a preferred example, the first bearing point, the second bearing point and/or the further bearing point is movable in a direction generally perpendicular to the interface axis of the first assembly. It is of advantage in this example when the first bearing has a portion that is couplable to the second assembly and can be pivoted about a pivot axis lying in a plane relatively perpendicular to the interface axis, for example. In particular, in some examples, it is of advantage if the connectable portion is movable in a linear manner along a direction of the pivot axis relative to the machine frame, and the second bearing also includes a portion that is couplable to the second assembly and can be pivoted about a pivot axis lying in a plane substantially perpendicular to the interface axis. The pivot axis of the portions of the first and second bearing that are couplable to the second assembly and the interface axis of the first assembly preferably define a horizontal plane in this example. In addition, it is advantageous in some examples when the additional bearing point of the second assembly is arranged on a sliding surface formed on/onto the second assembly, and the additional bearing has a force transmission member that is supported on the sliding surface and shiftable in a linearly movable manner relative to the machine frame in a plane relatively perpendicular to the interface axis of the first assembly.

It is also a concept of examples disclosed herein that the two mutually opposed bearing points of the first assembly are movable relative to the machine frame along the horizontal plane corresponding to two independent degrees of movement freedom. The effect which can be achieved by this is that an axially symmetrical connection flange for connecting the second assembly to the first assembly can be oriented in such a manner that the axis of symmetry of the connection flange aligns with the interface axis of the first assembly.

Since a first assembly, which is implemented as a turbine in this example, is accommodated in the machine frame in a linearly movable manner along the direction of the axis of rotation of the turbine, it can be achieved that the thermal expansions of a second assembly, which is implemented as a recuperator, are not transmitted as thermally induced forces to the first assembly, for example.

For this purpose, the example plant system can include a first plain bearing arranged on the machine frame and a second plain bearing, which is arranged on the machine frame, to mount the first assembly on two mutually opposite bearing points in a horizontal plane, in which the interface axis of the first assembly is located.

In some examples, the two mutually opposite bearing points are shiftable/movable in correspondingly two translational degrees of movement freedom, which are independent of each other, in the horizontal plane.

A third plain bearing for cushioning a tilting moment, which acts upon the first assembly, about a tilting axis passing through the two mutually opposite/opposed bearing points can also be provided on the machine frame, for example. The effect which can be achieved by this is that only small forces, if any at all, which may deform the turbine housing are introduced into the turbine housing of the turbine in a turbo module of the first assembly during coupling to the second assembly.

It is advantageous when the third plain bearing is removed from the machine frame for opening up movement space for the first assembly, for example. In particular, it can be advantageous when a supporting device, which is couplable to the machine frame, is provided with a further plain bearing that serves for cushioning the tilting moment, which acts upon the first assembly, about the tilting axis, which passes through the two mutually opposed/opposite bearing points, when the third plain bearing is removed from the machine frame to release or free up movement space for the first assembly.

In some examples, a first pivot bearing and a second pivot bearing for the mounting of the first assembly can also be provided on the machine frame. In such examples, the first pivot bearing can be pivoted in the second pivot bearing relative to the machine frame about at least one pivot axis passing through the horizontal plane. Further, a receptacle can also be provided here for the first assembly, where the receptacle is pivotable in the first pivot bearing relative to the machine frame about a pivot axis that is perpendicular to the pivot axis of the second pivot bearing, or a receptacle can be pivoted in the first pivot bearing relative to the machine frame about a pivot axis parallel to the pivot axis of the second pivot bearing.

The effect which can be achieved by implementing a positioning device for the manual or motor driven linearly movable shifting and/or moving of the first assembly in the direction of the interface axis being provided in the plant system is that the first assembly can be positioned very precisely relative to the second assembly for connection to the interface of the first assembly.

It is also a concept of examples disclosed herein that the positioning device can be designed as a module assembly that is connectable/couplable to the machine frame for the linear movement of the first assembly and is removable from the machine frame after the shifting.

Examples disclosed herein also extend to a method for arranging the first assembly in a plant system, comprising the following steps: arranging the first assembly on the machine frame, and shifting/moving the first assembly along the direction of the interface axis.

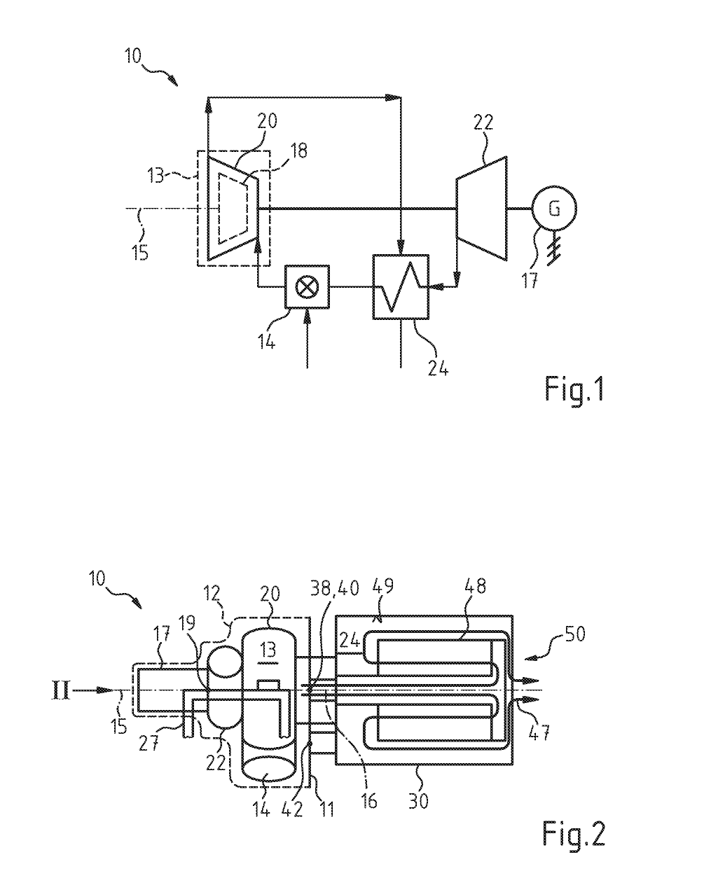

The example plant system 10 shown in FIG. 1 is a gas turbine system which, as a first assembly 12 (see FIG. 2), includes a turbo module with a turbine 13 that can be acted upon with hot gas from a combustion chamber 14. According to the illustrated example, the turbine 13 has a rotor 18, which is rotatable about an axis of rotation 15 and disposed/positioned in a turbine housing 20. The example turbine 13 releases an exhaust gas flow upon being acted upon with hot gas from the combustion chamber 14. The plant system 10 contains a compressor 22, which is rotationally coupled to the rotor 18, to generate compressed intake air, which can be provided to the combustion chamber 14. The compressor is part of the turbo module in this example. The plant system 10 of the illustrated example includes a second assembly 24 that is implemented as a recuperator to transfer heat from the exhaust gas flow to the intake air, which is compressed by the compressor 22. To generate electrical energy, the example plant system 10 includes a generator 17 that is part of the turbine module. The generator 17 includes a blade wheel, which is rotationally coupled to the rotor 18 of the turbine 13 in this example.

FIG. 2 is a schematic side view of the example plant system 10 with a machine frame 27 having a first assembly 12, which includes the turbo module with the turbine 13, the generator 17 and the compressor 22. The machine frame 27 of the illustrated example also mounts and/or bears the second assembly 24 that is coupled to the interface 11 of the first assembly 12 and implemented as a recuperator. The example interface 11 includes an interface axis 16 that is substantially coaxial to the axis of rotation 15 of the turbine 13.

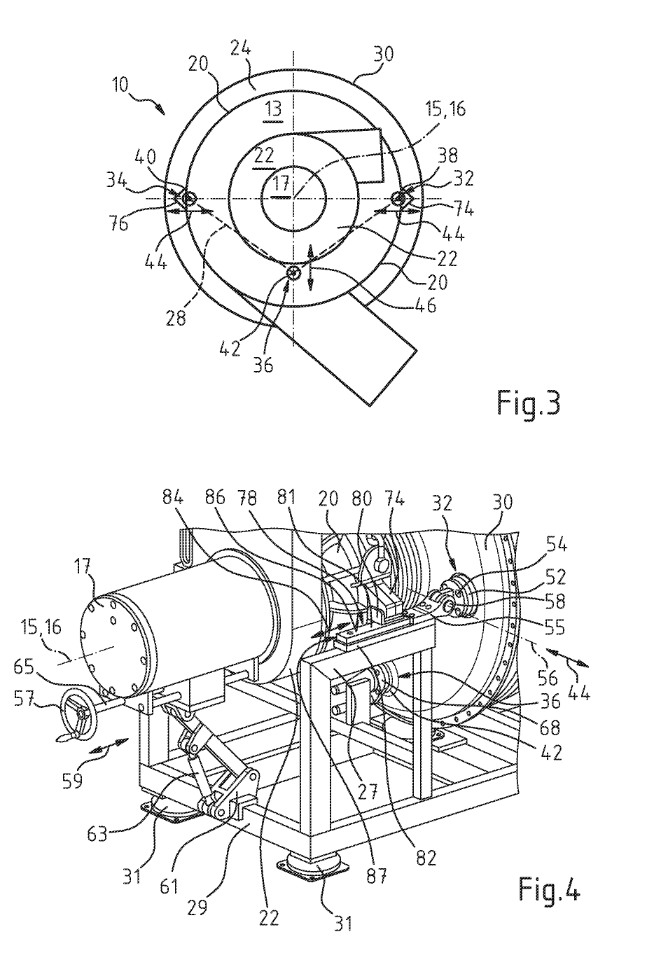

FIG. 3 is an additional schematic side view of the example plant system 10 along the direction of arrow II shown in FIG. 2. According to the illustrated example, the second assembly 24, which is implemented as the recuperator, includes a recuperator housing 30 that is accommodated (e.g., positioned, mounted) on the machine frame 27 by a three-point bearing 28. The three-point bearing 28 of the recuperator housing 30 includes, on the machine frame 27, a first bearing 32, a second bearing 34 spaced apart from the first bearing 32, and a further bearing 36 spaced apart from the first bearing 32 and the second bearing 34. In this example, the recuperator housing 30 is held/mounted on the machine frame on a first bearing point 38 of the first bearing 32. In this example, the second bearing 34 holds the recuperator housing 30 on a second bearing point 40 of the machine frame 27. On an additional bearing point 42, the recuperator housing 30 is held in the additional bearing 36 on the machine frame 27.

In this example, the first bearing point 38 and the second bearing point 40 on the recuperator housing 30 are each shiftable/movable relative to the machine frame 27 along the horizontal direction, which is perpendicular to the axis of rotation 15. In particular, the axis of rotation 15 is substantially coaxial with respect to the interface axis 16, as generally indicated by a double arrow 44. The additional bearing point 42 on the recuperator housing 30 can be moved relative to the machine frame 27 along the vertical direction 46 that is substantially perpendicular to the axis of rotation 15, which is coaxial with respect to the interface axis 16.

The recuperator of the illustrated example exhibits a rotationally symmetrical construction. Accordingly, the hot exhaust gas flow 47 of the turbine 13 is provided to the recuperator along the axial direction of the axis of rotation 15 of the turbine 13. Within the interior of the recuperator, the hot exhaust gas of the turbine 13 flows in a generally meandering manner through an annular heat exchanger structure 48 in a direction with an increasing distance of the axis of rotation 15 from the outer wall 49.

It should be noted that in an alternative example, the recuperator can also have a non-rotationally symmetrical construction. Particularly, the recuperator can be designed as a plate heat exchanger, in some examples.

In this example, the exhaust gas of the turbine 13 exits the recuperator again on its side 50, which faces away from the turbine 13, in the axial direction of the axis of rotation 15, which is coaxial with respect to the interface axis 16. By use of the heat exchanger structure 48, the residual heat contained in the hot exhaust gas is transmitted to the compressed intake air which is fed to the recuperator likewise in the axial direction of the axis of rotation 15 of the turbine 13.

FIG. 4 is a three-dimensional partial view of the plant system 10 with the machine frame 27 showing the first bearing 32 and the additional bearing 36. The machine frame 27 of the illustrated example includes a frame 29 with height-adjustable vibration dampers 31 arranged thereon. In this example, the first bearing 32 includes a bearing body with a flange portion 52 that is secured to the recuperator housing 30 on the side facing the turbine 13 by screws 54. Further, the example flange portion 52 of the bearing body is coupled in an articulated manner to a holding portion 55, which is secured on the machine frame 27 by screws 54. The flange portion 52 can be pivoted there about a pivot axis 56 intersecting the axis of rotation 15 of the rotor of the turbine 13 substantially perpendicularly. In this example, the flange portion 52 is guided in a linearly movable manner here by a spherical bearing on a pin 58 along the horizontal direction of the pivot axis 56, as generally indicated by the double arrow 44. This ensures that the first bearing point 38 can be shifted in the horizontal direction, which is substantially perpendicular to the axis of rotation 15, which is coaxial with respect to the interface axis 16, as indicated by the double arrow 44. In this example, the second bearing 34 has a construction corresponding to the first bearing 32.

With a positioning device 57 that can be arranged on the machine frame 27 for installation purposes, the generator 17 along with the compressor 22 and the turbine 13 can be shifted relative to the machine frame 27 in a direction generally indicated by the double arrow 59 that is substantially parallel to the axis of rotation 15 of the rotor of the turbine 13.

According to the illustrated example, the positioning device 57 is supported on the machine frame 27 via a link arrangement 61, which contains a length-adjustable link element 63 and a threaded rod mechanism. The example positioning device 57 includes a rotatable spindle 65 that is positioned in a pivotable bearing assembly and can act upon the first assembly 12 (having the turbine 13 and the compressor 22 and the generator 17) with an adjustment force generally acting along the direction of the axis 16 of the interface 11. By adjusting the length-adjustable link element 63, it is, thus, possible to place the bearing assembly for the rotatable spindle 65 onto the housing of the generator 17.

The effect which can thereby be achieved is that the mounting and removal of the first assembly 12 in the form of the turbo module on the machine frame 27 can be carried out by a single person, optionally with the aid of a lifting crane.

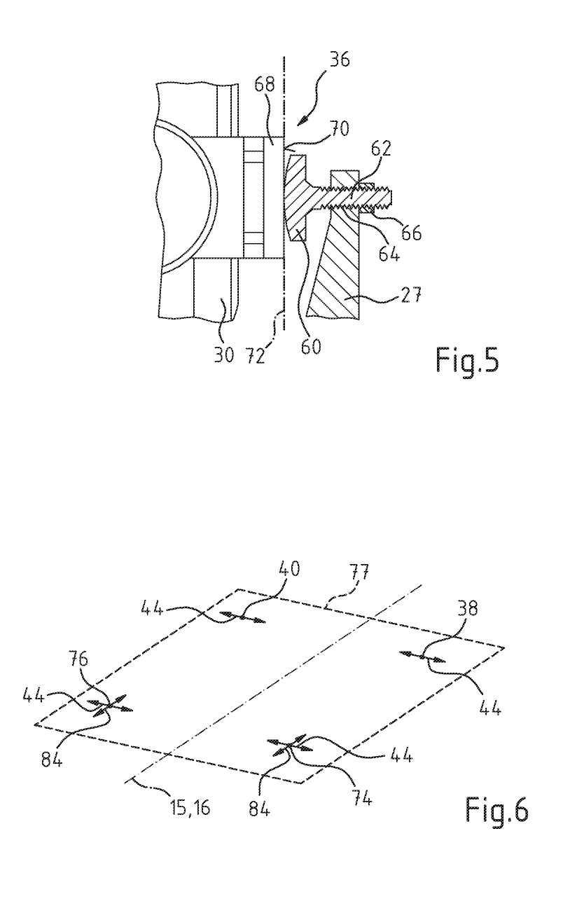

FIG. 5 shows a portion of the recuperator with the additional bearing 36, in which the recuperator housing 30 is mounted on the additional bearing point 42. The example bearing point 42 is shiftable/movable relative to the machine frame 27. The additional bearing 36 includes, as a force transmission member, an anvil 60 with a threaded portion 62 that is held on the machine frame 27 by a thread 64. The anvil 60 of the illustrated example is secured/coupled to the machine frame 27 via a lock nut 66. The additional bearing 36 includes a connection body 68, which is secured to the recuperator housing 30 by a sliding surface 70 for the anvil 60. The recuperator housing 30 is supported on the side facing the turbine 13 on the machine frame 27 by the anvil 60. The recuperator housing 30 can be shifted in this example relative to the anvil 60 along the plane 72, which is substantially perpendicular to the axis of rotation 15. By adjusting the anvil 60 on the machine frame 27, the recuperator housing 30 can be oriented with respect to the machine frame 27 and the turbine 13 accommodated therewith.

FIG. 6 shows an example arrangement of the bearing points 74, 76 of the turbine 13 and the bearing points 38, 40 of the recuperator housing 30 on the machine frame 27 with respect to the axis of rotation 15 of the rotor 18. The axis of rotation 15 is substantially coaxial with respect to the interface axis 16 in this example. The aforementioned three-point bearing 28 for the recuperator on the machine frame 27 has the effect that thermal expansion of the recuperator housing 30 does not result in any significant lifting (e.g., no lifting) of the second assembly 24, which is implemented as a recuperator. Accordingly, a thermal expansion of the recuperator housing 30 along the direction of the axis of rotation 15 of the turbine 13 is absorbed by the machine frame 27, and, therefore, the thermal expansion is not transmitted toward the turbine housing 20 of the turbine 13.

As can be seen in the examples of FIGS. 2, 4 and 6, the example machine frame 27 accommodates the turbine housing 20 of the turbine 13 on bearing points 74, 76 that lie in a horizontal plane 77, in which the axis of rotation 15 of the rotor 18 is arranged. To hold the turbine 13, the plant system 10 has a first plain bearing 78 arranged on the machine frame 27, and a second plain bearing, which is arranged on the machine frame 27 and lies opposite the first plain bearing 78. In this example, the construction of the second plain bearing corresponds to the construction of the first plain bearing 78. According to the illustrated example, in the first plain bearing 78 and in the second plain bearing, which lies opposite the first plain bearing 78, the turbine housing 20 of the turbine 13 is mounted on the bearing points 74, 76. The plain bearing 78 includes a first bearing body 80 that is coupled to the turbine housing 20. The example plain bearing 78 is arranged on a portion 82 of the machine frame 27 and, in addition to the first bearing body 80, includes a second bearing body 81. The first bearing body 80 is shiftable/movable on the second bearing body 81 on a guide surface 86 both perpendicularly to the axis of rotation 15 of the rotor 18 along the direction generally indicated by the double arrow 44 and perpendicularly thereto along the direction generally indicated by the double arrow 84 in the horizontal plane.

Accordingly, the example turbine 13 is held in the plain bearing 78 on the machine frame 27 in such a manner that the turbine housing 20 with the compressor 22 connected thereto, and the generator 17 coupled to the compressor 22, can move relative to the machine frame 27 in the horizontal plane 77 along the direction generally indicated by the double arrows 44, 84. The bearing points 74, 76, which are formed on the turbine housing 20, of the turbine 13 on the machine frame 27 can, thus, yield to a thermal expansion of assemblies in the plant system 10 without the turbine housing 20 being acted upon with forces which are asymmetrical with respect to the axis of rotation 15 of the turbine rotor 18 of the turbine 13.

Since the bearing points 74, 76 of the turbine housing 20 of the turbine 13 generally lie in the same horizontal plane 77 aligned with the axis of rotation 15 and the bearing points 38, 40 of the recuperator housing 30, thermal expansion of the turbine housing 20 during the operation of the turbine 13 does not generally lead to torsional moments that deform the turbine housing 20 and, thus, can impair the operation of the turbine 13.

In this example, the generator 17 and the compressor 22 of the turbo module in the first assembly 12 are held on and/or mounted on the turbine housing 20. The mass center of gravity 19, which is shown in FIG. 2, of the mass of the first assembly 12 (e.g., the mass of the turbine 13, the compressor 22 and the generator 17) is located on the interface of the connection/coupling of the turbine housing 20, the turbine 13 and the compressor 22. As a result, it is ensured that the mass center of gravity 19, which is shown in FIG. 2, is positioned relatively close (e.g., as close as possible) to the bearing points 74, 76 of the turbine housing 20 in such a manner that the bending moments introduced into the turbine housing 20 are relatively small.

For transport, the movable assemblies of the first plain bearing 78 and of the second plain bearing are fixed as far as possible by a clamping device (e.g., with packaging straps). Furthermore, for the transport, it can also be provided that the connection body 68, which is secured to the recuperator housing 30, can be coupled to the anvil 60 by use of a threaded interface and/or screwing into the threaded interface.

FIG. 7 is a partial view of an example additional machine frame 27′, which is alternative to the above-described machine frame 27, to accommodate a first assembly 12, which is implemented as a turbo module with a turbine 13, and a second assembly 24, which is implemented as a recuperator in the above-described example plant system 10. To the extent that the assemblies and elements shown in FIG. 7 correspond to the assemblies and elements from the above-described figures, they are identified with the same numbers as references. According of the illustrated example, the turbine housing 20 of the turbine 13 in the turbo module is held on the bearing points 74, 76 by the machine frame 27′. In this particular example, each instance of a receptacle 90 is mounted pivotably in a first spherical bearing 92, which has a first pivot axis 94. The example first spherical bearing 92 is held on a bearing body 96 in an additional spherical bearing 98, which has an additional pivot axis 100 that is perpendicular to the first pivot axis 94. According to the illustrated example, in the receptacle 90, the respective bearing points 74, 76 of the turbine housing 20 of the turbine 13 are shiftable/movable in a linearly movable manner along the direction of the first pivot axis 94, as generally indicated by the double arrow 102 and relative to the machine frame 27′, as generally indicated by the double arrow 44. To support the bearing body 96 on the machine frame 27′, a length-adjustable supporting member 104 of the illustrated example is implemented. The supporting member 104 is coupled to the machine frame 27′ by a spherical bearing and to the bearing body 96 by an additional spherical bearing.

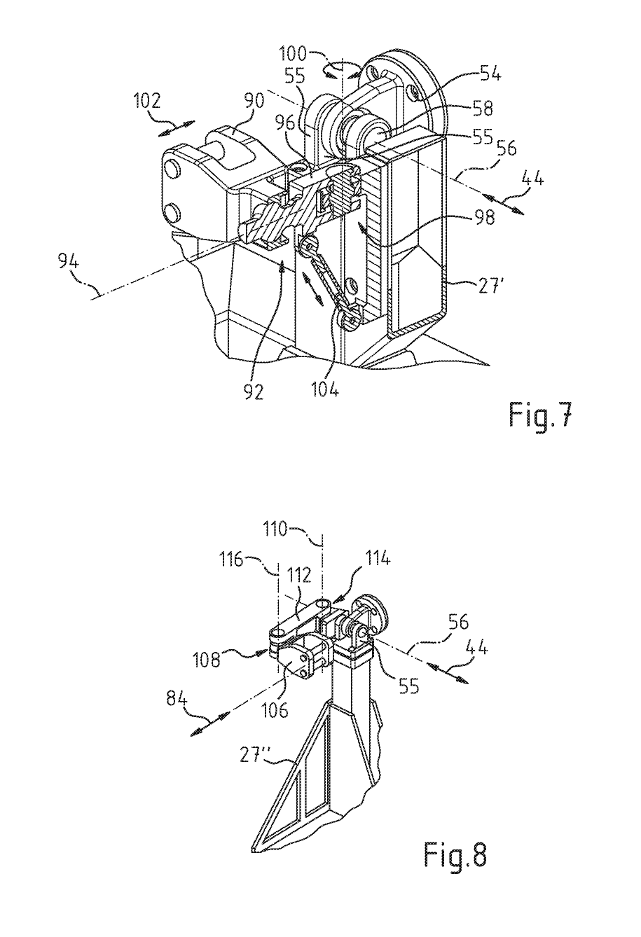

FIG. 8 shows a partial view of an example additional machine frame 27″, which is alternative to the above-described example machine frames 27, 27′, to accommodate a first assembly implemented as the turbo module with a turbine 13 and a second assembly 24, which is implemented as a recuperator, in the above-described plant system 10 that is implemented as a gas turbine plant. To the extent that the assemblies and elements shown in FIG. 8 correspond to the assemblies and elements from the above-described figures, these are identified by the same numbers as reference signs.

According to the illustrated example, the housing of the turbine 13 is held on the bearing points 74, 76 by a receptacle 106 that is accommodated in a first pivot bearing 108. The first pivot bearing 108 includes a first vertical pivot axis 116 and is held on a bearing body 112 in an additional pivot bearing 114 with an additional vertical pivot axis 110. In the receptacle 106, the bearing points 74, 76 can be shifted or moved in a linearly movable manner relative to the machine frame 27′ along the horizontal direction generally indicated by the double arrows 44 and 84.

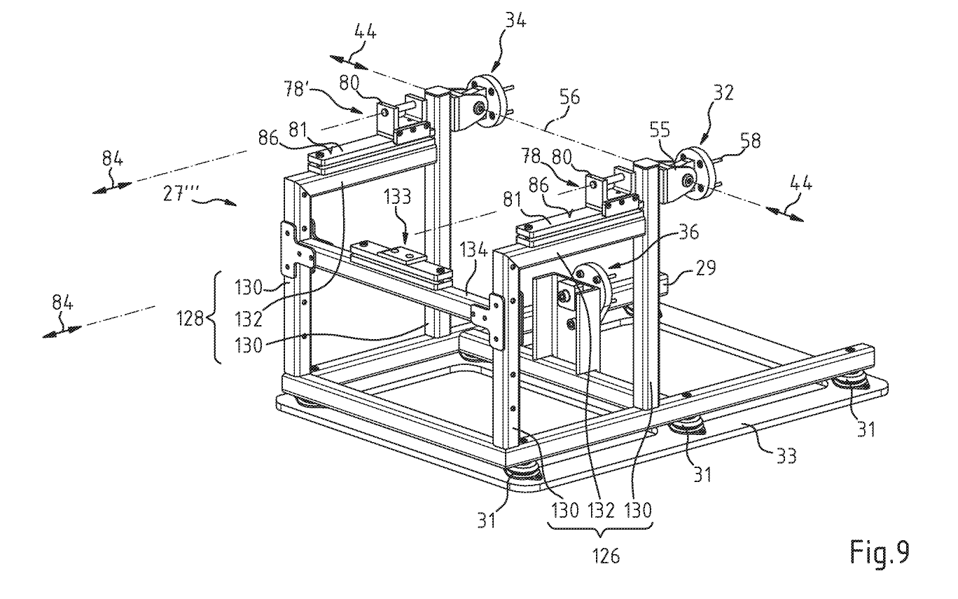

FIG. 9 shows a fourth example machine frame 27′″, which is alternative to the above-described example machine frames 27, 27′ and 27″, to accommodate the first assembly 12 and the second assembly 24 in the plant system 10 of FIGS. 1, 2 and 3. To the extent that the assemblies and elements shown in FIG. 9 correspond to the assemblies and elements from the above-described figures, these are identified by the same numbers as reference signs.

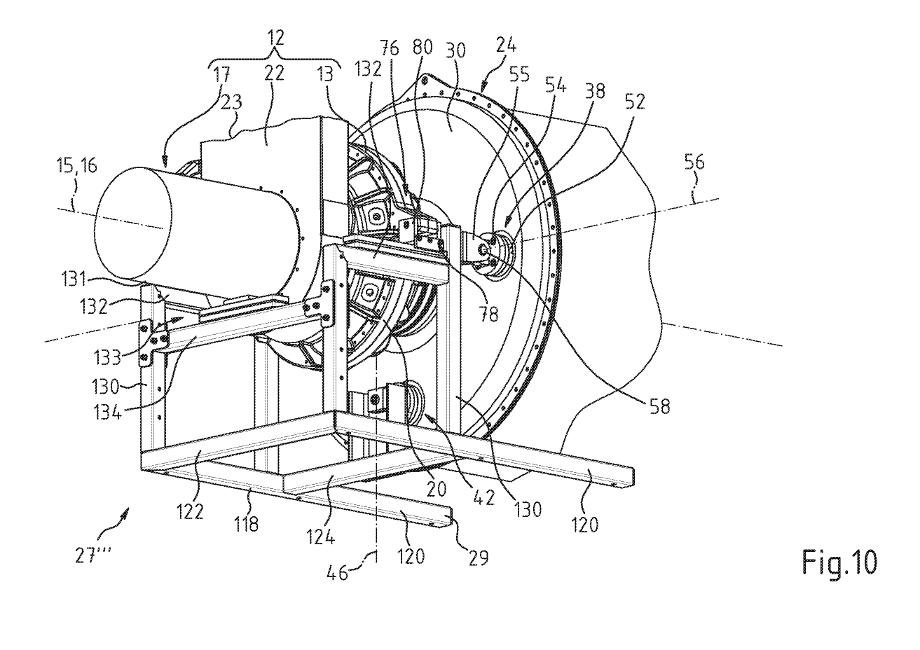

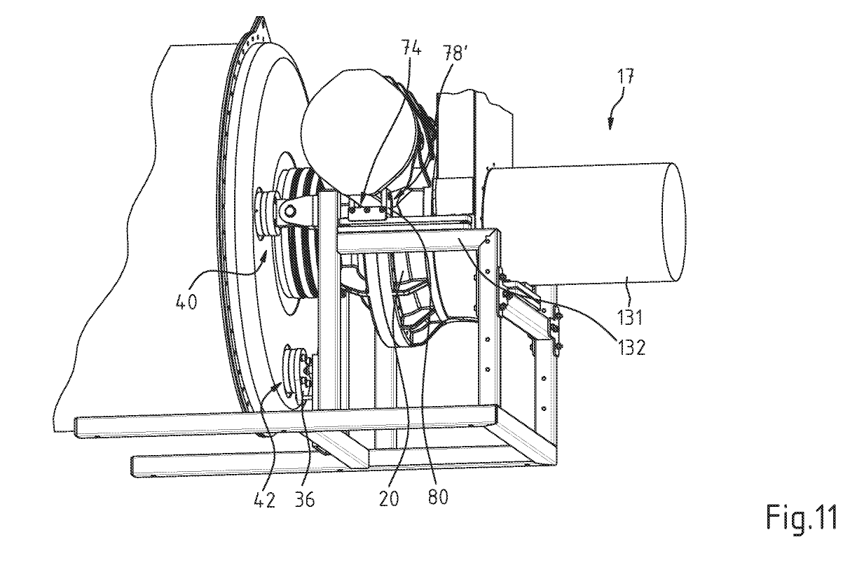

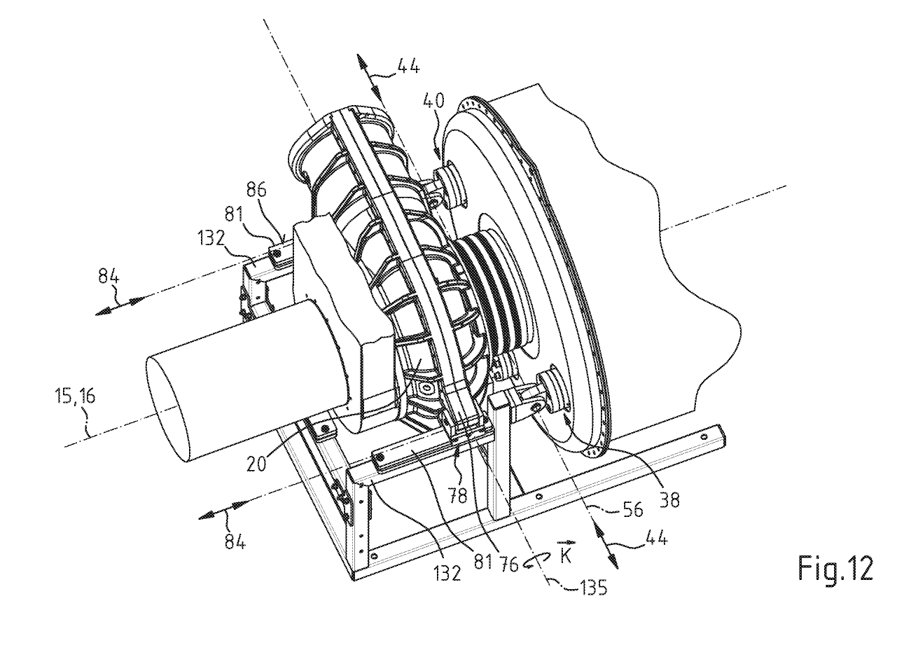

FIG. 10 is a perspective partial view of the plant system 10, which is shown in FIGS. 1 and 2, with the example fourth machine frame 27′″ and the first assembly 12, which is accommodated thereon and implemented as the turbo module with the turbine 13, and the second assembly 24, which is accommodated on the machine frame and implemented as a recuperator. FIG. 11 and FIG. 12 are further perspective partial views of the plant system 10 with the fourth machine frame 27″′.

The machine frame 27′″ of the illustrated example includes a frame 29 that mounts the first assembly 12 with the turbine 13 and the generator 17, which is fixedly coupled to the turbine 13, where the compressor 22 is arranged in the turbo module between the turbine 13 and the generator 17, with an intake device 23 for air.

In this example, the aforementioned height-adjustable vibration dampers 31 are coupled to the frame 29 of the machine frame 27′″ and mount the machine frame 27′″ on a base 33 to ensure a relatively smooth and generally low-wear operation of the turbine 13 in the example plant 10.

According to the illustrated example, the frame 29 of the machine frame 27′″ has a floor-side supporting portion 118 with two longitudinal beams 120 that are relatively parallel to one other. The example longitudinal beams 120 are extended in the plant system below the first assembly 12 and the second assembly 24. In this example, the mutually parallel longitudinal beams 120 are coupled by a first transverse strut 122 and a further transverse strut 124 and, together with the aforementioned transverse struts, define a framework that bears a first supporting device 126 and a second supporting device 128, both of which includes two supports 130 that are vertical with respect to the longitudinal beams 120 and coupled by a transverse beam 132, which is substantially parallel to the longitudinal beams 120.

The recuperator of the second assembly 24 is accommodated in a three-point bearing 28 at its recuperator housing 30 on the machine frame 27′″, as in the example machine frame shown and described in connection with FIG. 4.

The example three-point bearing 28 of the recuperator housing 30 includes a first bearing 32, a second bearing 34 spaced apart from the first bearing 32, and an additional bearing 36 spaced apart from the first bearing 32 and the second bearing 34 on the machine frame 27′″.

In this example, the recuperator housing 30 is held on a first bearing point 38 in the first bearing 32 on the machine frame 27′″. Further, the second bearing 34 holds the recuperator housing 30 on a second bearing point 40 on the machine frame 27′″. At an additional bearing point 42, the recuperator housing 30 is held in the additional bearing 36 on the machine frame 27″′.

The first bearing 32 in this example includes a bearing body with a flange portion 52 that is secured to the recuperator housing 30 on the side facing the turbine 13 by screws 54. The example flange portion 52 of the bearing body is coupled in an articulated manner to a holding portion 55, which is secured to a vertical support 130 of the first or second supporting device 126, 128 of the machine frame 27″′.

The example flange portion 52 can be pivoted about a pivot axis 56 that substantially perpendicularly intersects the axis of rotation 15 of the rotor of the turbine 13. In this example, the flange portion 52 is held in a spherical bearing on a pin 58 and guided in a linearly movable manner in the horizontal direction along the pivot axis 56, as generally indicated by the double arrow 44. Accordingly, this ensures that the first bearing point 38 can be shifted in the horizontal direction, which is substantially perpendicular to the axis of rotation 15 that is coaxial with respect to the interface axis 16, as generally indicated by the double arrow 44. The second bearing 34 has a construction corresponding to the first bearing 32, for example.

According to the illustrated example, the first bearing point 38 and the second bearing point 40 on the recuperator housing 30 are each shiftable/movable relative to the machine frame 27′″ along the horizontal direction, which is substantially perpendicular to the axis of rotation 15 which, in turn, is substantially coaxial with respect to the interface axis 16, as generally indicated by the double arrow 44. The additional bearing point 42 on the recuperator housing 30 can be moved relative to the machine frame 27 along the vertical direction 46 that is substantially perpendicular to the axis of rotation 15.

In this example, on the machine frame 27′″, the turbo module of the first assembly 12 is accommodated on the transverse beam 132 of the first or second supporting device 126, 128 on first bearing points 74, 76 that lie in a horizontal plane 77 shown in FIG. 6. In this example, the axis of rotation 15 of the rotor 18 of the turbine 13 is positioned in the horizontal plane 77s.

In this example, the turbo module of the first assembly 12 is mounted on the machine frame 27′″ by a first plain bearing 78 and by a second plain bearing 78′ lying opposite of the first plain bearing 78.

The first and second plain bearings 78, 78′ of the illustrated example each have a first bearing body 80 that is coupled to the turbine housing 20. The example plain bearings 78, 78′ are located on the transverse beam 132 of the first or second supporting device 126, 128, on which a second bearing body 81 that is complementary to the first bearing body 80 is formed.

The first bearing body 80 of the illustrated example is shiftable/movable on the second bearing body 81 along a guide surface 86 perpendicular to the axis of rotation 15 of the rotor 18, as generally indicated by the double arrow 44, and also perpendicular to, along the direction generally indicated by the double arrow 84, in the horizontal plane 77 shown in FIG. 6.

Accordingly, the turbine 13 is positioned in the plain bearing 78 on the machine frame 27 in such a manner that the turbine housing 20 along with the compressor 22 coupled thereto and the generator 17 coupled therewith can move relative to the machine frame 27 in the horizontal plane 77 along the direction generally indicated by the double arrows 44, 84. The example bearing points 74, 76, which are defined on the turbine housing 20 of the turbine 13 on the machine frame 27 can, thus, yield to a thermal expansion of assemblies in the plant system 10 without the turbine housing 20 encountering forces that are asymmetrical with respect to the axis of rotation 15 of the turbine rotor 18 of the turbine 13.

Because the example bearing points 74, 76 of the turbine housing 20 of the turbine 13 generally lie in the same horizontal plane 77 as the axis of rotation 15 and the bearing points 38, 40 of the recuperator housing 30, a thermal expansion of the turbine housing 20 during operation of the turbine 13 does not generally lead to significant torsional moments, which can deform the turbine housing 20 and impair operation of the turbine 13.

According to the illustrated example, the generator 17 and the compressor 22 of the turbo module of the first assembly 12 in the plant 10 are held on the turbine housing 20. The generator housing 142 of the generator 17 is supported on the machine frame 27′″ by an additional, third plain bearing 133, for example.

The third plain bearing 133 can be defined on the machine frame 27′″ on a removable transverse beam 134 that couples the vertical supports 130 of the first and second supporting device 126, 128, where the supports face away from the second assembly 24 implemented as the recuperator, for example.

The example third plain bearing 133 cushions a tilting moment about a tilting axis 135 that passes through the two bearing points 74, 76. In particular, the first assembly 12 experiences the tilting moment because of the weights of the generator 17 and the compressor 22.

According to the illustrated example, the transverse beam 134, which accommodates the third plain bearing 133, stabilizes the machine frame 27″′. However, the transverse beam 134 in combination with the third plain bearing 133 prevents the first assembly 12 and the turbo module from moving in the example plant system 10 from a side of the first or second supporting device 126, 128, respectively, facing the second assembly 17 to a side facing away from the second assembly 17 to permit maintenance work on or exchange of the turbo module.

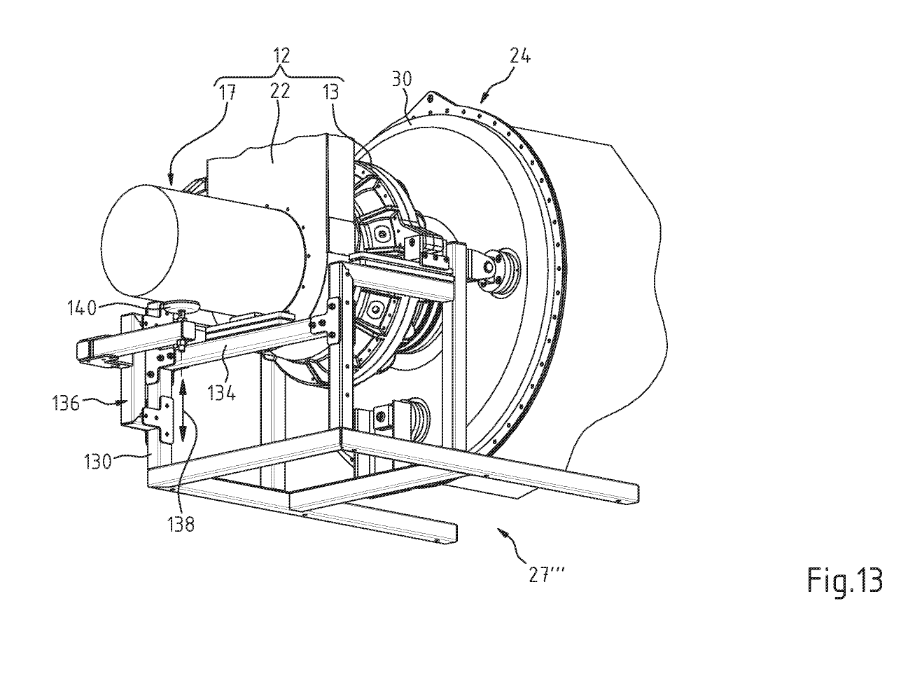

FIG. 13 is a partial view of the plant system with the fourth example machine frame 27″′. FIG. 13 shows the fourth machine frame 27″′ with a supporting device 136 that is additionally coupled to a vertical support 130 and bears/mounts a further plain bearing 140, which is adjustable in a direction generally indicated by a double arrow 138 and serves to mount the generator 17 on the generator housing 142.

The example supporting device 136 is fitted for installation or removal of the first assembly 12 with the turbo module onto or from the machine frame 27′″ to support the additional plain bearing 133 on the machine frame 27′″ and open up, increase and/or free up movement space here for the first assembly 12.

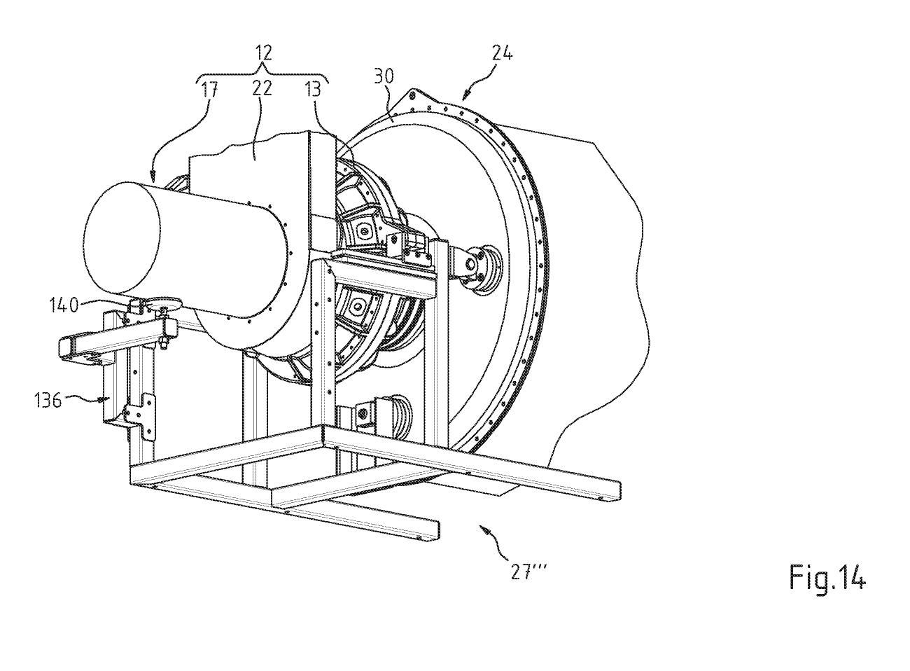

FIG. 14 is a further partial view of the plant system 10 and shows the fourth example machine frame 27′″ with the supporting device 136 for supporting the generator 17 when the transverse beam 134 (shown in FIG. 13) of the machine frame 27′″ is removed. Accordingly, the example supporting device 136 ensures that tilting moments that act on the machine frame 27′″ on the first assembly 12, which is implemented as a turbo module, are moved to the machine frame 27′″.

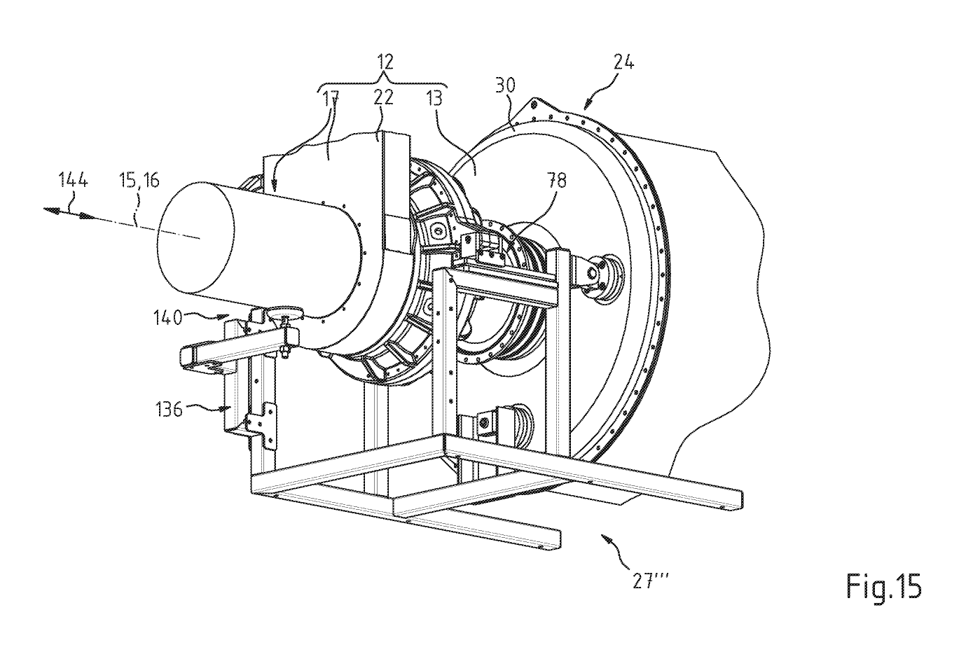

FIG. 15 shows a partial view of the example plant system 10, in which the first assembly 12 is released from the second assembly 24. In this example, the turbo module of the first assembly 12 can be moved in a plane corresponding to the horizontal plane 77 shown in FIG. 6 along a direction generally indicated by the double arrow 144 of the plain bearings 78, 78′ of the machine frame 27′″ and the plain bearing 140 of the supporting device 136.

In summary, following aspects should be noted:

Example 1 includes a plant system 10 with a first assembly 12 accommodated on a machine frame 27, 27′, 27″, and including a second assembly 24 connected to an interface 11 of the first assembly 12, where the interface 11 has an interface axis 16 along which a force flux and/or torque flux and/or media flux can take place from the first assembly 12 into the second assembly 24 via the interface 11 and where the machine frame 27, 27′, 27″ also bears the second assembly 24.

Example 2 includes the plant system as defined in Example 1, where the second assembly 24 is accommodated on the machine frame 27, 27′, 27″ at a three point bearing 28 which has a first bearing 32 formed on the machine frame 27, 27′, 27″, a second bearing 34 which is formed on the machine frame 27, 27′, 27″ and is spaced apart from the first bearing 32, and a further bearing 36 formed on the machine frame 27, 27′, 27″, where the second assembly 24 is accommodated on a first bearing point 38 in the first bearing 32 and on a second bearing point 40 in the second bearing 34 and on a further bearing point 42 in the further bearing 36.

Example 3 includes the plant system as defined in Example 2, where the first bearing point 38 and/or the second bearing point 40 and/or the further bearing point 42 are/is shiftable in a direction perpendicular to the interface axis 16.

Example 4 includes the plant system as defined in Examples 2 or 3, where the first bearing 32 has a portion 52, which is connectable to the second assembly 24 and can be pivoted about a pivot axis 56 lying in a plane 72 perpendicular to the interface axis 16.

Example 5 includes the plant system as defined in Example 4, where the portion 52 is shiftable in a linearly movable manner in the direction of the pivot axis 56 relative to the machine frame 27.

Example 6 includes the plant system as defined in Examples 4 or 5, where the pivot axis 56 together with the interface axis 16 spans a horizontal plane 77.

Example 7 includes the plant system as defined in one of Examples 2 to 6, where the second bearing 34 has a portion 52, which is connectable to the second assembly 24 and can be pivoted about a pivot axis 56 lying in a plane perpendicular to the interface axis 16.

Example 8 includes the plant system as defined in Example 7, where the portion 52 is shiftable in a linearly movable manner in the direction of the pivot axis 56 relative to the machine frame 27.

Example 9 includes the plant system as defined in Examples 7 or 8, where the pivot axis 56 together with the interface axis 16 spans a horizontal plane 77.

Example 10 includes the plant system as defined in one of Examples 2 to 9, where the further bearing point 42 is arranged on a sliding surface 70 formed on the second assembly 24, and the further bearing 36 has a force transmission member, which is supported on the sliding surface 70 and is shiftable in a linearly movable manner relative to the machine frame 27, 27′, 27′″ in the plane perpendicular to the interface axis 16.

Example 11 includes the plant system as defined in one of Examples 1 to 10, where the first assembly 12 is accommodated on the machine frame 27, 27′, 27″ so as to be shiftable in a linearly movable manner in the direction of the interface axis 16.

Example 12 includes the plant system as defined in Example 11, and further includes a first plain bearing 78 arranged on the machine frame 27, 27′, 27″, and a second plain bearing, which is arranged on the machine frame 27, 27′, 27″, for mounting the first assembly 12 on two mutually opposite bearing points 74, 76 in a horizontal plane 77, where the interface axis 16 is arranged in the horizontal plane 77.

Example 13 includes the plant system as defined in Example 12, where the two mutually opposite bearing points 74, 76 are shiftable in correspondingly two degrees of movement freedom, which are independent of each other, in the horizontal plane 77.

Example 14 includes the plant system as defined in one of Examples 11 to 13, and further includes a first spherical bearing 92 arranged on the machine frame 27, 27′, 27′ and a second spherical bearing 98 arranged on the machine frame 27, 27′, 27″ for the mounting of the first assembly 12.

Example 15 includes the plant system as defined in Example 14, where the first spherical bearing 92 can be pivoted in the second spherical bearing 98 relative to the machine frame 27′ about at least one pivot axis 100 passing through the horizontal plane 77.

Example 16 includes the plant system as defined in Examples 14 or 15, which comprises a receptacle 90 for the first assembly 12, which receptacle can be pivoted in the first spherical bearing 92 relative to the machine frame 27′ about a pivot axis 94, which is perpendicular to the pivot axis 100 of the second spherical bearing 98.

Example 17 includes the plant system as defined in one of Examples 11 to 13, and further includes a first pivot bearing 108 arranged on the machine frame 27, 27′, 27″ and a second pivot bearing 114 arranged on the machine frame 27, 27′, 27″ for the mounting of the first assembly 12.

Example 18 includes the plant system as defined in Example 17, where the first pivot bearing 108 can be pivoted in the second pivot bearing 114 relative to the machine frame 27″ about at least one pivot axis 100, 116 passing through the horizontal plane 77.

Example 19 includes the plant system as defined in Examples 17 or 18, and further includes a receptacle 106, which can be pivoted in the first pivot bearing 108 relative to the machine frame 27″ about a pivot axis 116 parallel to the pivot axis 110 of the second pivot bearing 114.

Example 20 includes a plant system, which is designed as a gas turbine system, as defined in one of Examples 1 to 19, where the first assembly 12 is a turbo module, which contains a turbine 13 that can be acted upon with hot gas from a combustion chamber 14, has a turbine rotor 18, which is arranged in a turbine housing 20 and rotatable about an axis of rotation 15, which is coaxial with respect to the interface axis 16, and which upon being acted upon with hot gas from the combustion chamber 14 releases an exhaust gas flow, and which has a compressor 22, which is rotationally coupled to the turbine rotor 18 for generating compressed additional air that can be fed into the combustion chamber 14, and the second assembly 24 is a recuperator that is connected to the interface 11 with the turbo module and can be acted upon in the direction of the interface axis 16 with the exhaust gas flow for transferring heat from the exhaust gas flow to the additional air, which is compressed by the compressor 22.

Example 21 includes the plant system as defined in one of Example 1 to 20, and further includes a positioning device 57, which is supported on the machine frame 27, 27′, 27″, for the manual or motor driven linearly movable shifting of the first assembly 12 in the direction of the interface axis 16 relative to the machine frame 27, 27′, 27″.

Example 22 includes the plant system as defined in Example 21, where the positioning device is designed as a module assembly that is connectable to the machine frame 27, 27′, 27″ for the linearly movable shifting of the first assembly 12 and is removable from the machine frame 27, 27′, 27″ after the shifting.

Example 23 includes a method for arranging the first assembly in a plant system as defined in one of Examples 1 to 22, which includes the following steps: arranging the first assembly 12 on the machine frame 27, 27′, 27″; and shifting the first assembly 12 in the direction of the interface axis 16.

This patent arises as a continuation-in-part of International Patent Application No. PCT/EP2017/054212, which was filed on Feb. 23, 2017, which claims priority to German Patent Application No. 10 2016 203 620, which was filed on Mar. 4, 2016. The foregoing International Patent Application and the German Patent Application are hereby incorporated herein by reference in their entireties.

Although certain example methods, apparatus and articles of manufacture have been disclosed herein, the scope of coverage of this patent is not limited thereto. On the contrary, this patent covers all methods, apparatus and articles of manufacture fairly falling within the scope of the claims of this patent.

What is claimed is:

1. A plant system comprising:
a first assembly carried by a machine frame; and
a second assembly coupled to an interface of the first assembly, wherein the interface has an interface axis along which at least one of a force flux, a torque flux, or a media flux is to pass from the first assembly and into the second assembly via the interface, wherein the machine frame carries the second assembly, and wherein the first assembly is carried by the machine frame to be movable in a linear manner along the direction of the interface axis.

2. The plant system as defined in claim 1, wherein the first assembly is a turbine module that contains a turbine, and the second assembly is a recuperator, wherein the turbine includes a turbine rotor with an axis of rotation coaxial to the interface axis, wherein the turbine can be provided with hot gas from a combustion chamber, wherein the turbine, upon being provided with hot gas from the combustion chamber, releases an exhaust gas flow, wherein the turbine includes a compressor, which is rotationally coupled to the turbine rotor, to generate compressed additional air to be provided to the combustion chamber, and wherein the second assembly can be provided with in the direction of the interface axis with the exhaust gas flow for transferring heat from the exhaust gas flow to the additional air, which is compressed by the compressor.

3. The plant system as defined in claim 1, further including:
a first plain bearing arranged on the machine frame; and
a second plain bearing that is arranged on the machine frame for mounting the first assembly on two mutually opposing bearing points in a horizontal plane, wherein the interface axis is arranged in the horizontal plane.

4. The plant system as defined in claim 3, wherein the two mutually opposed bearing points are movable along two degrees of movement freedom, both of which are independent of each other in the horizontal plane.

5. The plant system as defined in claim 3, further including a third plain bearing, which is arranged on the machine frame, to cushion a tilting moment, which acts upon the first assembly, about a tilting axis passing through the two mutually opposed bearing points.

6. The plant system as defined in claim 5, wherein the third plain bearing is to be removed from the machine frame to increase movement space for the first assembly.

7. The plant system as defined in claim 6, further including:
a supporting device that is couplable to the machine frame; and
an additional plain bearing for cushioning the tilting moment, which acts upon the first assembly, about the tilting axis that passes through the two mutually opposed bearing points when the third plain bearing is removed from the machine frame for freeing up movement space for the first assembly.

8. The plant system as defined in claim 1, further including:
a first receptacle for holding the first assembly; and
a second receptacle for holding the first assembly, wherein the first receptacle is mounted pivotably in a first spherical bearing which has a first pivot axis, wherein the second receptacle is pivotably mounted in an additional first spherical bearing that has an additional first pivot axis, and where the first spherical bearing and the additional first spherical bearing are each held on a bearing body in a second spherical bearing and on a bearing body in a further second spherical bearing on the machine frame, wherein each of the two first spherical bearings can be pivoted in the respective second spherical bearing relative to the machine frame about an additional pivot axis that passes through the horizontal plane and is perpendicular to the first pivot axis or the further first pivot axis.

9. The plant system as defined in claim 1, further including:
a first receptacle for holding the first assembly; and
a second receptacle for holding the first assembly, wherein the first receptacle is held in a first pivot bearing, which is carried by a second pivot bearing arranged on the machine frame, and wherein the second receptacle is held in a further first pivot bearing, which is carried by a further second pivot bearing arranged on the machine frame, wherein the second pivot bearing can be pivoted in the first pivot bearing relative to the machine frame about a pivot axis perpendicular to the horizontal plane, wherein the further second pivot bearing is to be pivoted in the further first pivot bearing relative to the machine frame about a further pivot axis that is perpendicular to the horizontal plane, and wherein the first pivot bearing and the further first pivot bearing each have a pivot axis which is parallel to the second pivot bearing and to the further second pivot bearing.

10. A plant system comprising:
a first assembly carried by a machine frame; and
a second assembly connected to an interface of the first assembly, wherein the interface has an interface axis along which at least one of a force flux, a torque flux, or a media flux can pass from the first assembly into the second assembly via the interface, wherein the machine frame carries the second assembly, wherein the second assembly is carried by the machine frame at a three-point bearing which has a first bearing formed on the machine frame, a second bearing which is formed on the machine frame and is spaced apart from the first bearing, and a further bearing formed on the machine frame, wherein the second assembly 24 is mounted on a first bearing point in the first bearing and on a second bearing point in the second bearing and on a further bearing point in the further bearing, wherein at least one of the first bearing point, the second bearing point, or the additional bearing point is movable in a direction substantially perpendicular to the interface axis, where the first bearing includes a portion, which is couplable to the second assembly and can be pivoted about a pivot axis lying in a plane that is relatively perpendicular to the interface axis, and at least one of:
the portion is movable in a linearly movable manner along the direction of the pivot axis relative to the machine frame, or
the pivot axis and the interface axis span a horizontal plane.

11. The plant system as defined in claim 10, wherein the first assembly is implemented as a turbine module which contains a turbine, and the second assembly is implemented as a recuperator, wherein the turbine has a turbine rotor with an axis of rotation that is coaxial with respect to the interface axis, and wherein the turbine can be provided with hot gas from a combustion chamber, wherein the turbine upon being provided with hot gas from the combustion chamber releases an exhaust gas flow, wherein the turbine has a compressor, which is rotationally coupled to the turbine rotor to generate additional compressed air to be provided into the combustion chamber, and wherein the second assembly can be provided with in the direction of the interface axis with the exhaust gas flow for transferring heat from the exhaust gas flow to the additional air that is compressed by the compressor.

12. The plant system as defined in claim 1, wherein the second assembly is carried by the machine frame at a three-point bearing that includes a first bearing formed on the machine frame, a second bearing formed on the machine frame and spaced apart from the first bearing, and an additional bearing formed on the machine frame, wherein the second assembly is mounted on a first bearing point in the first bearing and on a second bearing point in the second bearing and on an additional bearing point in the additional bearing, wherein at least one of the first bearing point, the second bearing point, or the further bearing point is movable in a direction substantially perpendicular to the interface axis, wherein the first bearing includes a portion that is connectable to the second assembly and can be pivoted about a pivot axis lying in a plane substantially perpendicular to the interface axis, and wherein at least one of:
the portion is movable in a linear manner along the direction of the pivot axis relative to the machine frame, or
the pivot axis and the interface axis span a horizontal plane.

13. The plant system as defined in claim 12, wherein the second bearing includes a portion that is couplable to the second assembly and can be pivoted about a pivot axis lying in a plane perpendicular to the interface axis, wherein at least one of the portion is movable in a linearly movable manner in the direction of the pivot axis relative to the machine frame, or the pivot axis and the interface axis span a horizontal plane, and wherein the further bearing point is arranged on a sliding surface formed on the second assembly, and the additional bearing has a force transmission member that is supported on the sliding surface and is movable in a linear manner relative to the machine frame along the plane substantially perpendicular to the interface axis.

14. A plant system comprising:
a first assembly carried by a machine frame; and
a second assembly coupled to an interface of the first assembly, wherein the interface includes an interface axis along which at least one of a force flux, a torque flux, or a media flux can pass from the first assembly and into the second assembly via the interface, wherein the machine frame carries the second assembly, the second assembly including a positioning device, which is supported on the machine frame, for the manual or motor-driven linear movement of the first assembly in the direction of the interface axis relative to the machine frame.

15. The plant system as defined in claim 14, wherein the first assembly is implemented as a turbine module which contains a turbine, and the second assembly is implemented as a recuperator, wherein the turbine includes a turbine rotor with an axis of rotation that is coaxial with respect to the interface axis, and wherein the turbine can be provided with hot gas from a combustion chamber, wherein the turbine, upon being provided with hot gas from the combustion chamber, releases an exhaust gas flow, wherein the turbine includes a compressor, which is rotationally coupled to the turbine rotor, for generating compressed additional air that can be provided into the combustion chamber, and wherein the second assembly can be provided with in the direction of the interface axis with the exhaust gas flow for transferring heat from the exhaust gas flow to the additional air, which is compressed by the compressor.

16. The plant system as defined in claim 1, further including a positioning device, which is supported on the machine frame, for the manual or motor-driven linear movement of the first assembly along the direction of the interface axis relative to the machine frame.

17. The plant system as defined in claim 16, wherein the positioning device is designed as a module assembly that is couplable to the machine frame for the linear movement of the first assembly and is removable from the machine frame after the movement.

18. A method for arranging the first assembly in a plant system as defined in claim 1, which comprises the following steps:
arranging the first assembly on the machine frame; and
moving the first assembly in the direction of the interface axis.
